(19) United States
(12) Patent Application Publication
(10) Pub. No.: US 2015/0022545 A1
(43) Pub. Date: Jan. 22, 2015

(54) METHOD AND APPARATUS FOR GENERATING COLOR IMAGE AND DEPTH IMAGE OF OBJECT BY USING SINGLE FILTER

(71) Applicant: Samsung Electronics Co., Ltd., Suwon-si (KR)

(72) Inventors: Byong-min KANG, Yongin-si (KR); Do-kyoon KIM, Seongnam-si (KR); Jung-soon SHIN, Yongin-si (KR)

(73) Assignee: Samsung Electronics Co., Ltd., Suwon-si (KR)

(21) Appl. No.: 14/291,759

(22) Filed: May 30, 2014

(30) Foreign Application Priority Data
Jul. 18, 2013 (KR) 10-2013-0084927

(51) Int. Cl. G06T 5/00; H04N 1/60

(52) U.S. Cl. CPC G06T 5/00; H04N 1/60; H04N 1/6077
USPC 345/600

(57) ABSTRACT

An apparatus for generating an image representing an object is provided. The apparatus may include a filtering unit configured to acquire first light of a first wavelength band and second light of a second wavelength band, which are included in light reflected from the object, by using a single filter; a sensing unit configured to convert both the first light and the second light into charges or convert only the second light into charges; a first image generating unit configured to generate a first image representing the object by correcting color values corresponding to the charges into which the first light and the second light have been converted; and a second image generating unit configured to generate a second image representing the object by using the charges into which the second light has been converted.

### CROSS-REFERENCE TO RELATED APPLICATIONS

This application claims the priority benefit of Korean Patent Application No. 10-2013-0084927, filed on Jul. 18, 2013, in the Korean Intellectual Property Office, the disclosure of which is incorporated herein in its entirety by reference.

### BACKGROUND

1. Field

Embodiments relate to methods and apparatuses for generating a color image and a depth image of an object by using a single filter.

2. Description of the Related Art

As a method of acquiring a depth image of an object, there is a time-of-flight (ToF) method that irradiates infrared light (IR) onto an object and uses a time taken for the irradiated IR to return to an irradiation position by being reflected from the object. A ToF depth camera using this method may acquire a depth of an object from all pixels in real time, as compared with other usual cameras (e.g., stereo cameras and structured light cameras) that acquire a depth image of an object.

In general, not only a depth image of an object but also a color image of the object are necessary to generate a three-dimensional (3D) image of the object. To this end, a color camera is installed around a ToF depth camera to acquire a color image and a depth image. However, the use of the two cameras increases the size of an image generation system. Also, since the two cameras have different view-points, the acquired two images should be matched.

Recently, research is being conducted into a method of acquiring a color image and a depth image by using one sensor. In general, a visible pass filter should be provided outside the sensor in order to acquire a color image, and an infrared pass filter should be provided outside the sensor in order to acquire a depth image. Thus, in a method of acquiring a color image and a depth image by using one sensor, a visible pass filter and an infrared pass filter are provided outside the sensor. To this end, there are a method of using a mechanical filter device to control the wavelength of light filtered by a filter and a method of transmitting a predetermined wavelength of light by electrically changing the characteristics of a filter.

However, in these methods, an additional time is necessary to driving the filter, thus reducing a color/depth image acquisition speed. Also, since the size of a filtering device is large, the size of an image generating device increases.

### SUMMARY

Provided are methods and apparatuses for generating a color image and a depth image of an object by using a single filter.

Provided are computer-readable recording media that store a program for executing the above methods in a computer.

Additional aspects will be set forth in part in the description which follows and, in part, will be apparent from the description, or may be learned by practice of the presented embodiments.

According to an aspect of one or more embodiments, there is provided an apparatus for generating an image representing an object which includes: a filtering unit configured to acquire first light of a first wavelength band and second light of a second wavelength band, which are included in light reflected from the object, by using a single filter; a sensing unit configured to convert both the first light and the second light into charges or convert only the second light into charges; a first image generating unit configured to generate a first image representing the object by correcting color values corresponding to the charges into which the first light and the second light have been converted; and a second image generating unit configured to generate a second image representing the object by using the charges into which the second light has been converted.

According to an aspect of one or more embodiments, there is provided a method for generating an image representing an object which includes: acquiring first light of a first wavelength band and second light of a second wavelength band, which are included in light reflected from the object; converting both the first light and the second light into charges or converting only the second light into charges; generating a first image representing the object by correcting color values corresponding to the charges into which the first light and the second light have been converted; and generating a second image representing the object by using the charges into which the second light has been converted.

According to an aspect of one or more embodiments, there is provided at least one non-transitory computer readable medium storing computer readable instructions to implement methods of embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects will become apparent and more readily appreciated from the following description of embodiments, taken in conjunction with the accompanying drawings in which:

FIG. 1 is a block diagram illustrating an example of an image generating apparatus;

FIG. 2 is a graph illustrating an example of first light and second light;

FIGS. 3A-3C is an example illustrating an operation of a first image generating unit;

FIGS. 4A-4B are conceptual diagrams illustrating an example of an operation of a sensor included in a sensing unit (specifically, a photodiode circuit included in the sensor);

FIG. 5 is a timing diagram illustrating an example of an operation of a sensor included in a sensing unit (specifically, a photodiode circuit included in the sensor);

FIGS. 6A-6B is an example illustrating an operation of a second image generating unit;

FIG. 7 is a flow diagram illustrating an example of an image generating method; and

FIG. 8 is a circuit diagram illustrating an example of a column unit and a depth pixel included in a sensor.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. As used herein, the term “and/or” includes any and all combinations of one or more of the associated listed items.

Hereinafter, exemplary embodiments will be described in detail with reference to the accompanying drawings.

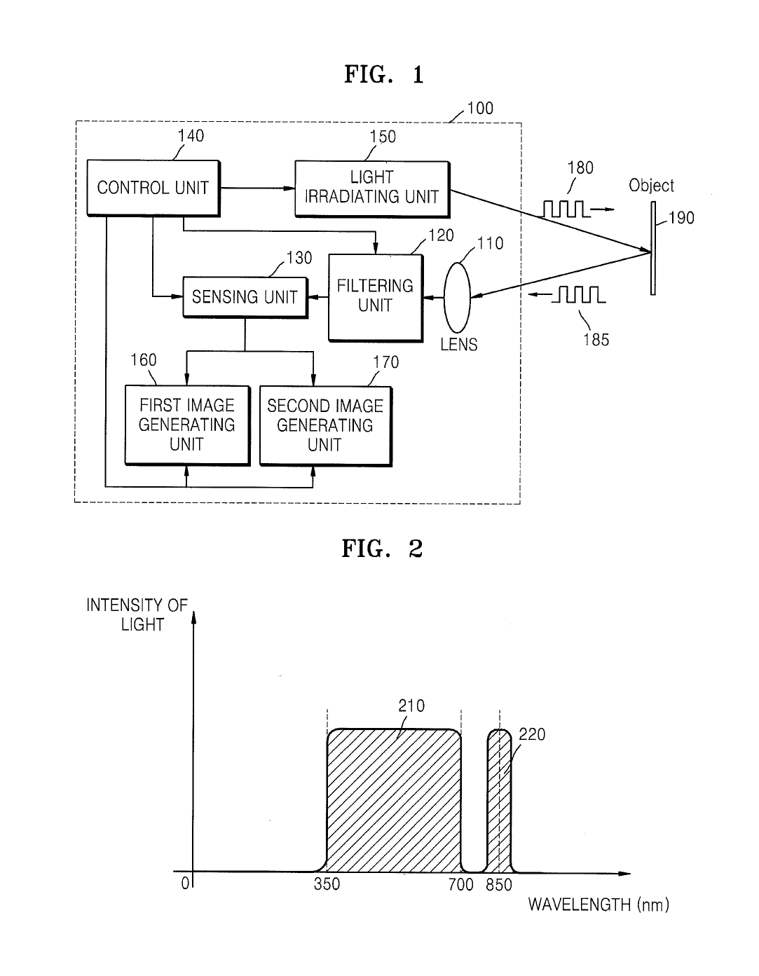

FIG. 1 is a block diagram illustrating an example of an image generating apparatus 100.

Referring to FIG. 1, the image generating apparatus 100 includes a lens 110, a filtering unit (filter) 120, a sensing unit (sensor) 130, a control unit (controller) 140, a first image generating unit (first image generator) 160, and a second image generating unit (second image generator) 170. Also, the image generating apparatus 100 may further include a light irradiating unit 150.

In the image generating apparatus 100 of FIG. 1, only elements related to this embodiment are illustrated. Therefore, those of ordinary skill in the art will understand that the image generating apparatus 100 may further include other general-purpose elements in addition to the elements illustrated in FIG. 1.

Also, the sensing unit 130, the control unit 140, the light irradiating unit (light irradiator) 150, the first image generating unit 160, and the second image generating unit 170 of the image generating apparatus 100 illustrated in FIG. 1 may correspond to one or more processors. The processor may be implemented by a plurality of logic gates, or may be implemented by a combination of a general-purpose microprocessor and a memory storing a program that may be executed in the microprocessor. Also, those of ordinary skill in the art will understand that the processor may also be implemented by other types of hardware.

Hereinafter, functions of the respective elements included in the image generating apparatus 100 will be described in detail with reference to FIG. 1.

The lens 110 acquires light input into the image generating apparatus 100. In detail, the lens 110 acquires reflected light 185 reflected from an object 190, and transmits the acquired reflected light 185 to the filtering unit 120.

The filtering unit 120 acquires first light of a first wavelength band and second light of a second wavelength band, which are included in the reflected light 185 reflected from the object 190. Herein, the first light may be visible light, and the second light may be infrared light; however, embodiments are not limited thereto. The first light and the second light will be described below in detail with reference to FIG. 2.

FIG. 2 is a graph illustrating an example of the first light and the second light.

In the graph of FIG. 2, a horizontal axis represents a wavelength of light, and a vertical axis represents an intensity (power) of light. The unit of the horizontal axis and the vertical axis may be any unit that may represent a wavelength of light and an intensity of light.

The filtering unit 120 (see FIG. 1) acquires first light 210 of a first wavelength band and second light 220 of a second wavelength band from light transmitted from the lens 110 (see FIG. 1). That is, the filtering unit 120 (see FIG. 1) may include a multiple band-pass filter that may transmit light of a plurality of wavelength bands. Herein, the first light 210 may be visible light, and the second light 220 may be infrared light. In detail, the second light 220 may be near-infrared light.

A color image is generated by using visible light (the first light 210), and a depth image is generated by using near-infrared light (the second light 220). However, not only the visible light 210 and the near-infrared light 220 but also light of other wavelength bands are included in the reflected light 185 (see FIG. 1) reflected from the object 190 (see FIG. 1). Therefore, the filtering unit 120 (see FIG. 1) removes light of other wavelength bands, other than the first light 210 and the second light 220, from the reflected light 185 (see FIG. 1).

Referring to FIG. 2, the wavelength band of the first light 210 is about 350 nm to about 700 nm, and the wavelength band of the second light 220 is about 850 nm; however, embodiments are not limited thereto. For example, the wavelength band of the first light 210 and the wavelength band of the second light 220 may be modified according to a first image and a second image that are to be generated by the image generating apparatus 100 (see FIG. 1). Herein, the wavelength band of the first light 210 and the wavelength band of the second light 220 may be automatically modified by the control unit 140 (see FIG. 1) without user intervention, or may be modified by the control unit 140 (see FIG. 1) based on user input information.

Referring to FIG. 1, the filtering unit 120 according to an embodiment includes a single filter. That is, the filtering unit 120 acquires the first light 210 (see FIG. 2) and the second light 220 (see FIG. 2) from the reflected light 185 by using the single filter. The filtering unit 120 transmits the first light 210 (see FIG. 2) and the second light 220 (see FIG. 2) to the sensing unit 130.

In general, in the image generating apparatus 100, two different filters are provided to acquire the first light 210 (see FIG. 2) and the second light 220 (see FIG. 2) that have different wavelength bands. Herein, the two different filters may be two filters that are physically separated from each other.

However, the filtering unit 120 according to an embodiment acquires the first light 210 (see FIG. 2) and the second light 220 (see FIG. 2) by using a single static filter. In detail, the single static filter acquires both the first light 210 (see FIG. 2) and the second light 220 (see FIG. 2) that are included in the reflected light 185.

Therefore, it is possible to prevent the size of the image generating apparatus 100 from increasing because physically-separated two filters are provided in the image generating apparatus 100. Also, since an additional time for filter driving is not necessary, the image generating apparatus 100 may rapidly generate the first image and the second image.

In FIG. 1, the filtering unit 120 is illustrated as being located between the lens 110 and the sensing unit 130; however, the filtering unit 120 may be located in front of the lens 110. When the filtering unit 120 is located in front of the lens 110, the lens 110 transmits the first light 210 (see FIG. 2) and the second light 220 (see FIG. 2), which are received from the filtering unit 120, to the sensing unit 130.

When the image generating apparatus 100 generates the second image, the light irradiating unit 150 irradiates third light, which is modulated with a predetermined frequency included in the second wavelength band, onto the object 190. In detail, the light irradiating unit 150 irradiates irradiated light 180, which is modulated with a predetermined frequency included in the second wavelength band, onto the object 190 based on a control signal of the control unit 140.

Referring to FIG. 2, as described above, the depth image (second image) representing the object 190 is generated by using infrared light (specifically, near-infrared light). Therefore, when the image generating apparatus 100 generates the second image, the light irradiating unit 150 irradiates the irradiated light 180, which is modulated with a predetermined wavelength corresponding to near-infrared light, onto the object 190. The lens 110 acquires the reflected light 185 including light obtained when the irradiated light 180 is reflected from the object 190.

The sensing unit 130 converts both the first light 210 (see FIG. 2) and the second light 220 (see FIG. 2) into charges or converts only the second light 220 (see FIG. 2) into charges. In detail, based on a control signal of the control unit 140 to be described later, the sensor included in the sensing unit 130 converts both the first light 210 (see FIG. 2) and the second light 220 (see FIG. 2) into charges or converts only the second light 220 (see FIG. 2) into charges.

The sensing unit 130 transmits the charges into which the first light 210 (see FIG. 2) and the second light 220 (see FIG. 2) have been converted, to the first image generating unit 160. Also, the sensing unit 130 transmits the charges into which only the second light 220 (see FIG. 2) has been converted (specifically, charges detected with a predetermined phase difference by photodiode circuits included in the sensor, among the charges into which the second light 220 (see FIG. 2) has been converted), to the second image generating unit 170.

The sensor included in the sensing unit 130 may include a photodiode array or a photogate array that may convert the first light 210 (see FIG. 2) and/or the second light 220 (see FIG. 2) into charges. Herein, the photodiode may be a pint photodiode, but is not limited thereto.

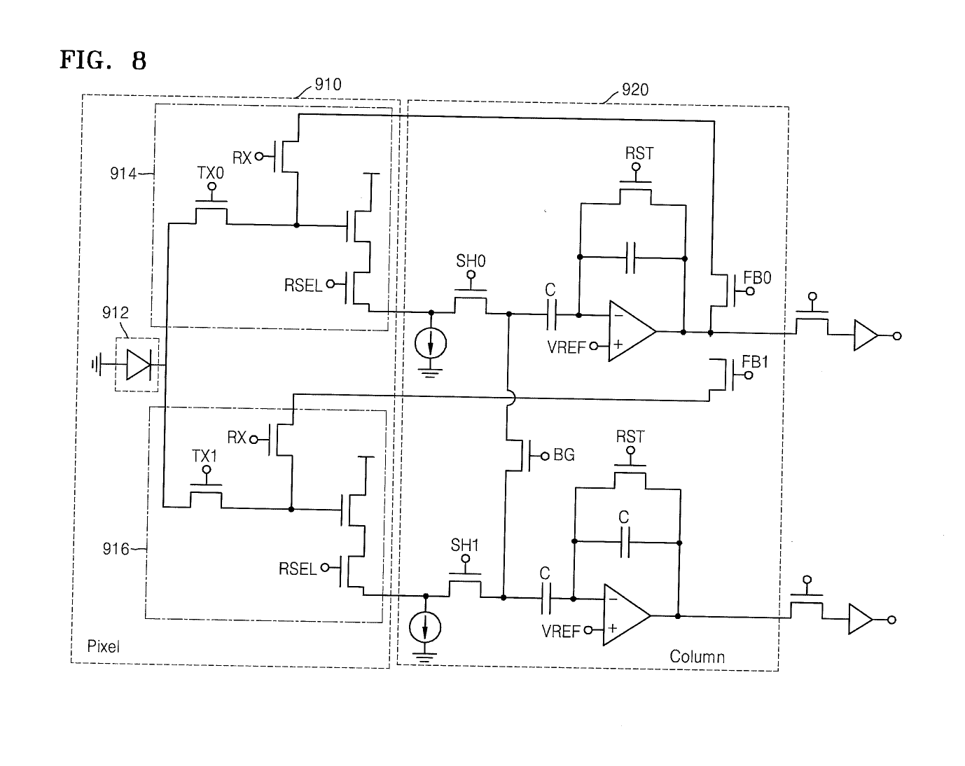

FIG. 8 is a circuit diagram illustrating an example of a column unit and a depth pixel included in the sensor.

According to an embodiment, two storage nodes storing charges are provided in a depth pixel 910 in the form of a floating diffusion node; however, two or more storage nodes may be provided. Therefore, the configuration of the sensor according to an embodiment is not limited to the circuit diagram illustrated in FIG. 8. Also, a photodiode 912 illustrated in FIG. 8 may be a pint photodiode or a photogate array.

Referring to FIG. 8, the structure of the depth pixel 910 and a column unit 920 includes two 4-transistor (T) color pixels. That is, two 4-T color pixels 914 and 916 (hereinafter referred to as photodiode circuits) are connected in parallel to each other. However, the difference from the related art structure is that a gate signal is connected not to a drain (VDD) of a reset transistor RX but to an output terminal of a correlated double sampling (CDS) amplifier in a column.

Also, in FIG. 8, two CDS amplifier circuits in a column are allocated to one depth pixel; however, embodiments are not limited thereto. That is, only one CDS amplifier circuit may be provided. A transistor driven by a back-gate (BG) signal is located between column lines connected to both nodes.

Each of the depth pixels 910 included in the sensor may include two photodiode circuits 914 and 916 that are connected in parallel to each other. The sensor may convert the first light 210 and the second light 220 into charges by transmitting the first light 210 and the second light 220 to only one of the two photodiode circuits 914 and 916 that are connected in parallel to each other. Also, the sensor may convert only the second light 220 into charges by transmitting the first light 210 and the second light 220 to both of the two photodiode circuits 914 and 916 that are connected in parallel to each other.

As described above, the structure of the sensor according to an embodiment is not limited to the circuit diagram of FIG. 8, as long as it may convert the first light 210 and the second light 220 into charges or convert only the second light 220 into charges.

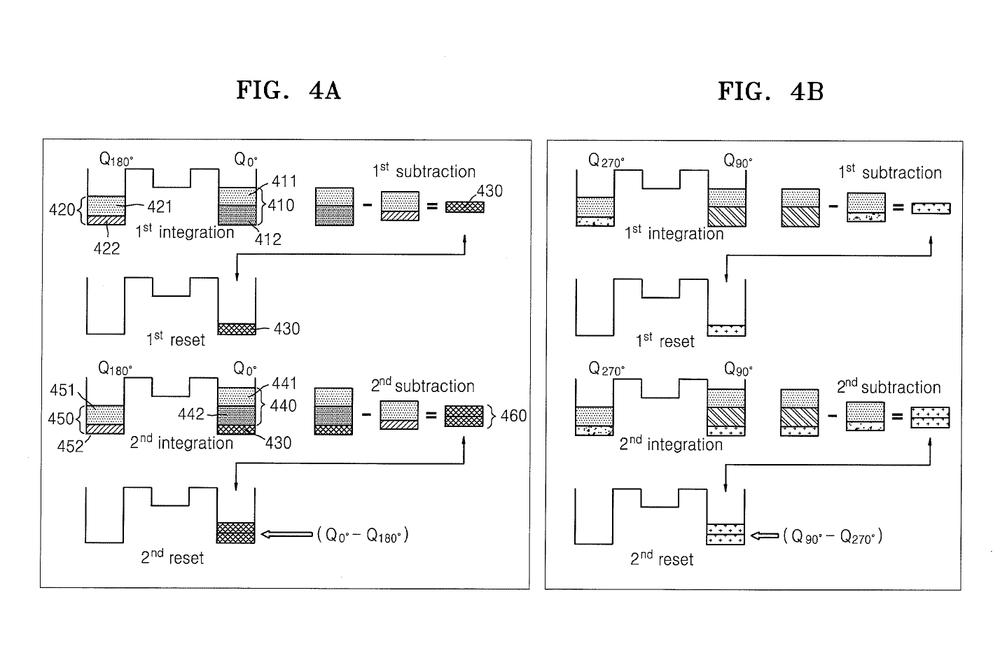

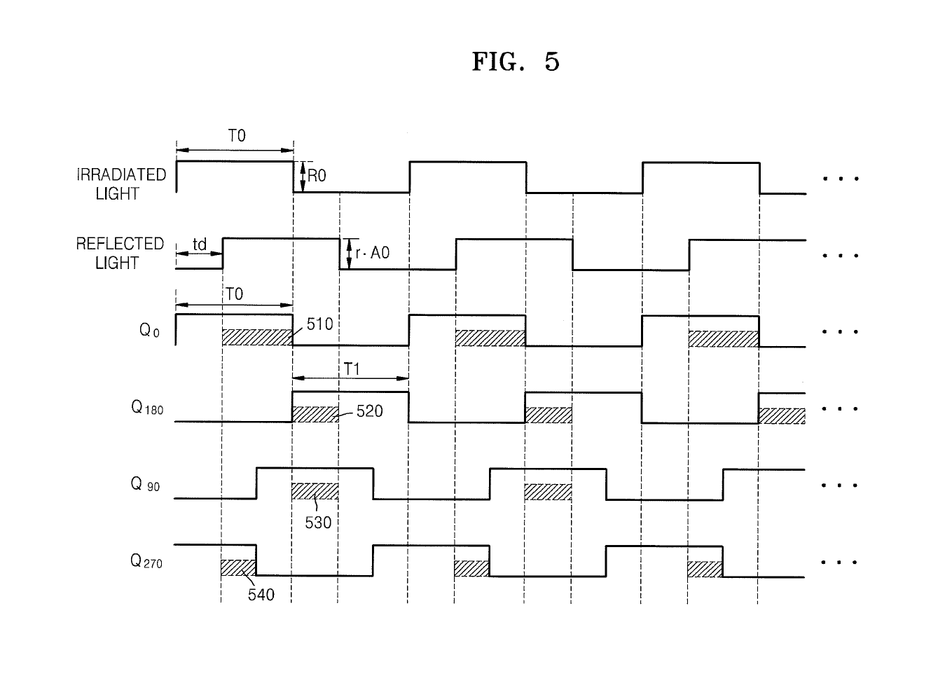

Referring to FIG. 1, an operation of the sensor for converting only the second light 220 (see FIG. 2) into charges (specifically, detecting charges with a predetermined phase difference by the photodiode circuits 914 and 916 (see FIG. 8) included in the sensor, among the charges into which the second light 220 (see FIG. 2) has been converted) will be described later in detail with reference to FIGS. 4 and 5.

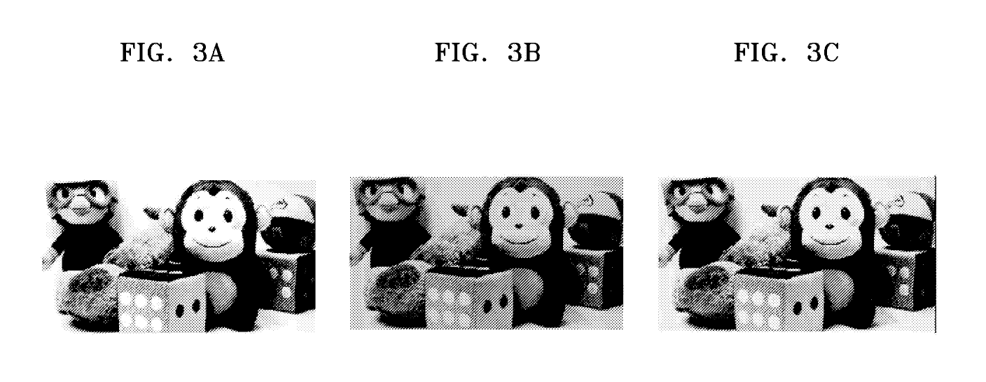

The first image generating unit 160 generates the first image representing the object 190 by correcting color values corresponding to the charges into which the first light 210 (see FIG. 2) and the second light 220 (see FIG. 2) have been converted. In detail, the first image generating unit 160 may correct color values of respective pixels included in an image, based on the maximum color values of the sensor included in the sensing unit 130. The first image generating unit 160 generates the first image by correcting the color values of the respective pixels. An operation of the first image generating unit 160 for generating the first image will be described below in detail with reference to FIG. 3.

FIGS. 3A-3C is an example illustrating an operation of the first image generating unit 160 (see FIG. 1).

Referring to FIGS. 3A-3C, FIG. 3A illustrates an original color of the object 190 (see FIG. 1), and FIG. 3B illustrates a color-distorted image of the object 190 (see FIG. 1) that is generated by using the charges into which the first light 210 (see FIG. 2) and the second light 220 (see FIG. 2) have been converted. Also, FIG. 3C illustrates the first image that is generated by correcting the color values of the pixels of the image by the first image generating unit 160 (see FIG. 1).

Referring to FIG. 3B, it may be seen that the image generated by using the charges into which the first light 210 (see FIG. 2) and the second light 220 (see FIG. 2) have been converted has a color distortion in comparison with the original colors of the object 190 (see FIG. 1) illustrated in FIG. 3A. In detail, the color of the object 190 (see FIG. 1) is represented by visible light. However, charges input into the first image generating unit 160 (see FIG. 1) include not only charges into which the first light 210 (see FIG. 2) corresponding to visible light has been converted, but also charges into which the second light 220 (see FIG. 2) corresponding to near-infrared light has been converted. Therefore, when an image is generated by using the charges input into the first image generating unit 160 (see FIG. 1), the image has a distorted color in comparison with the original color of the object 190 (see FIG. 1).

Therefore, the first image generating unit 160 (see FIG. 1) generates the first image as illustrated in FIG. 3C, by correcting the color values of the respective pixels included in the color-distorted image. In detail, the first image generating unit 160 generates an image (that is, a color-distorted image of the object 190 (see FIG. 1)) by using the charges into which the first light 210 (see FIG. 2) and the second light 220 (see FIG. 2) have been converted. Thereafter, the first image generating unit 160 (see FIG. 1) corrects the color values by using a white balance method. However, the white balance method is merely an example, and an embodiment may include any method that may correct a distorted color of an image.

The first image generating unit 160 (see FIG. 1) may correct the color values by Equation 1 below.

$$[ \begin{matrix}R \\ G \\ B\end{matrix} ] = [ \begin{matrix}\frac{255}{{R}^{′} w} & 0 & 0 \\ 0 & \frac{255}{{G}^{′} w} & 0 \\ 0 & 0 & \frac{255}{{B}^{′} w}\end{matrix} ] [ \begin{matrix}{R}^{′} \\ {G}^{′} \\ {B}^{′}\end{matrix} ] \qquad [ Equation 1 ]$$

In Equation 1, R′, G′, and B′ denote the color values of the respective pixels included in the image (i.e., FIG. 3B) that is generated by the charges into which the first light 210 (see FIG. 2) and the second light 220 (see FIG. 2) have been converted. Also, Rw′, Gw′, and Bw′ denote the maximum color value of the sensor included in the sensing unit 130 (see FIG. 1). For example, Rw′, Gw′, and Bw′ may denote an integer, such as 255 or 127, that is a numerical representation of the maximum color value of the sensor. Also, R, G, and B denote a color value of the corrected pixel.

The first image generating unit 160 (see FIG. 1) may generate the high-definition first image (e.g., a color image) of the object 190 (see FIG. 1) by correcting the color-distorted image (FIG. 3B) based on Equation 1, even when the filtering unit 120 (see FIG. 1) transmits both the first light 210 (see FIG. 2) and the second light 220 (see FIG. 2) to the sensing unit 130 (see FIG. 1).

Referring to FIG. 1, the second image generating unit 170 generates the second image representing the object 190 by using the charges into which the second light 220 (see FIG. 2) has been converted. In detail, the second image generating unit 170 receives, from the sensing unit 130, charges detected when the photodiode circuits operate with a predetermined phase difference therebetween, among the charges into which the second light 220 (see FIG. 2) has been converted. Then, the second image generating unit 170 generates the second image by combining the received charges.

Herein, the predetermined phase difference may be about 180°. In detail, the sensing unit 130 detects the charges by operating another photodiode circuit with a phase difference of about 180° with respect to a reference (0°) of a period in which any one of the photodiode circuits operates. The sensing unit 130 detects the charges by operating any one of the photodiode circuits with a phase difference of about 90° with respect to the reference (0°) and operating another photodiode circuit with a phase difference of about 270° with respect to the reference (0°).

FIGS. 4A-4B are conceptual diagrams illustrating an example of an operation of the sensor included in the sensing unit 130 (see FIG. 1) (specifically, the photodiode circuit included in the sensor).

FIG. 4A is a conceptual diagram corresponding to the case where the sensor operates any one (hereinafter referred to as a first circuit) of the parallel-connected two photodiode circuits with the reference (0°) and operates another photodiode circuit (hereinafter referred to as a second circuit) with a phase difference of about 180° with respect to the reference (0°).

FIG. 4B is a conceptual diagram corresponding to the case where the sensor operates the first circuit with a phase difference of about 90° with respect to the reference (0°) and operates the second circuit with a phase difference of about 270° with respect to the reference (0°).

Herein, the reference (0°) is to operate the first circuit in synchronization with the irradiation time of the third light, the details of which will be described later with reference to FIG. 5. Also, as described above with reference to FIG. 1, the sensor may include the parallel-connected two photodiode circuits (i.e., the first circuit and the second circuit).

A mechanism to be described below with reference to FIG. 4A may also be similarly applied to FIG. 4B. That is, since FIG. 4B merely corresponds to the case of shifting the first circuit and the second circuit of FIG. 4A by 90°, those of ordinary skill in the art will readily understand that the sensor may perform an operation of FIG. 4B in the same manner as the mechanism of FIG. 4A. Therefore, an operation of the sensor will be described below only with reference to FIG. 4A.

First, the sensor operates the first circuit and the second circuit for a predetermined time to store charges 410 and 420 corresponding to the first light 210 (see FIG. 2) and the second light 220 (see FIG. 2) (first integration). Herein, since the first circuit and the second circuit has a phase difference of about 180° therebetween, a charge quantity 410 stored in the first circuit is different from a charge quantity 420 stored in the second circuit. However, a charge quantity 411 obtained from the first light, among the charge quantity 410 stored in the first circuit, is equal to a charge quantity 421 obtained from the first light, among the charge quantity 420 stored in the second circuit.

Thereafter, the sensor calculates a difference between the charge quantity 410 stored in the first circuit and the charge quantity 420 stored in the second circuit (first subtraction). As described above, the charge quantity 411 obtained from the first light stored in the first circuit is equal to the charge quantity 421 obtained from the first light stored in the second circuit. Therefore, a result 430 of the first subtraction is equal to a difference between the charge quantity 412 obtained from the second light stored in the first circuit is equal to the charge quantity 422 obtained from the second light stored in the second circuit.

Thereafter, the sensor resets the first circuit and the second circuit (first reset). In detail, in the sensor, the first circuit resets (feedback-operates) the remaining charge quantity except the result 430 of the first subtraction, and the second circuit resets the total charge quantity.

Thereafter, the sensor operates the first circuit and the second circuit for a predetermined time to store charges 440 and 450 corresponding to the first light 210 (see FIG. 2) and the second light 220 (see FIG. 2) (second integration). Herein, as described above, a charge quantity 440 stored in the first circuit is different from a charge quantity 450 stored in the second circuit, but a charge quantity 441 obtained from the first light, among the charge quantity 440 stored in the first circuit, is equal to a charge quantity 451 obtained from the first light, among the charge quantity 450 stored in the second circuit.

Thereafter, the sensor calculates a difference between the charge quantities 440 and 430 stored in the first circuit and the charge quantity 450 stored in the second circuit (second subtraction). As described above, the charge quantity 441 obtained from the first light stored in the first circuit is equal to the charge quantity 441 obtained from the first light stored in the second circuit. Therefore, a result 460 of the second subtraction is equal to the sum of the result 430 of the first subtraction and a difference between the charge quantity 442 obtained from the second light stored in the first circuit and the charge quantity 452 obtained from the second light stored in the second circuit.

Thereafter, the sensor resets the first circuit and the second circuit (second reset). In detail, in the sensor, the first circuit resets (feedback-operates) the remaining charge quantity except the result 460 of the second subtraction, and the second circuit resets the total charge quantity. Accordingly, only a charge quantity (Q_{0°}−Q_{180°}) corresponding to the result 460 of the second subtraction exists in the first circuit and the second circuit.

As illustrated in FIG. 4B, the sensor operates the first circuit with a phase difference of about 90° with respect to the reference and operates the second circuit with a phase difference of about 270° with respect to the reference, to acquire a charge quantity (Q_{90°}−Q_{270°}). Herein, a mechanism of the sensor for acquiring the charge quantity (Q_{90°}−Q_{270°}) is the same as described with reference to FIG. 4A.

Referring to FIG. 1, the sensor transmits the acquired charge quantities (Q_{0°}−Q_{180°} and Q_{90°}−Q_{270°}) to the second image generating unit 170.

FIG. 5 is a timing diagram illustrating an example of an operation of the sensor included in the sensing unit 130 (see FIG. 1) (specifically, the photodiode circuit included in the sensor).

FIG. 5 is a timing diagram of an example of the operation of the sensor described above with reference to FIG. 4. That is, FIG. 5 illustrates an example of the first integration and the second integration of FIG. 4.

Referring to FIG. 5, “irradiated light” denotes the irradiated light 180 (i.e., the third light) (see FIG. 1) that is irradiated onto the object 190 (see FIG. 1) by the light irradiating unit 150 (see FIG. 1). Also, “reflected light” denotes the reflected light 185 (see FIG. 1) reflected from the object 190 (see FIG. 1).

“Irradiated light” and “reflected light” have a predetermined phase difference therebetween. That is, since a time is taken for “irradiated light” to propagate to the object 190 (see FIG. 1) and a time is taken for “reflected light” to propagate to the lens 110 (see FIG. 1), the time of irradiation of “irradiated light” onto the object 190 (see FIG. 1) by the light irradiating unit 150 (see FIG. 1) is earlier by a predetermined time (td) than the time of arrival of “reflected light” at the lens 110 (see FIG. 1). Also, the intensity of “irradiated light” is different from the intensity of “reflected light”. That is, when “irradiated light” is reflected from the object 190 (see FIG. 1), since the reflectance (r) of light is determined according to the characteristics of materials of the object 190 (see FIG. 1), the intensity (r·A0) of “reflected light” is reduced by a predetermined ratio (r) in comparison with the intensity of “irradiated light”.

In FIG. 5, Q₀ denotes the case where the sensor operates the first circuit in synchronization with the time (T0) of irradiation of “irradiated light”, and Q₁₈₀ denotes the case where the sensor operates the second circuit with a phase difference of about 180° from the first circuit. Also, an interval in which Q₀ and Q₁₈₀ are high corresponds to an interval in which TX0 and TX1 of the first circuit and the second circuit are turned on, and an interval in which Q₀ and Q₁₈₀ are low corresponds to an interval in which TX0 and TX1 of the first circuit and the second circuit are turned off.

The sensor repeatedly turns on/off the first circuit in synchronization with the time (T0) of irradiation of “irradiated light”, and acquires input “reflected light” during an interval (T0) of the turn-on of the first circuit (510). Also, the sensor repeatedly turns on/off the second circuit with a phase difference of about 180° from the first circuit, and acquires input “reflected light” during an interval (T1) of the turn-on of the second circuit (520). Through this process, the first integration described above with reference to FIG. 4A is completed. Since the second integration may be performed in the same manner as the first integration described above, a detailed description thereof will be omitted herein.

In FIG. 5, Q₉₀ denotes the case where the sensor operates the first circuit with a phase difference of about 90° from Q₀, and Q₂₇₀ denotes the case where the sensor operates the second circuit with a phase difference of about 270° from Q₀. Also, an interval in which Q₉₀ and Q₂₇₀ are high corresponds to an interval in which TX0 and TX1 of the first circuit and the second circuit are turned on, and an interval in which Q₉₀ and Q₂₇₀ are low corresponds to an interval in which TX0 and TX1 of the first circuit and the second circuit are turned off.

As in the case of Q₀ and Q₁₈₀, the first integration and the second integration described above with reference to FIG. 4B may be completed by acquiring “reflected light” during an interval of the turn-on of the first circuit and the second circuit (530, 540). Therefore, a detailed description thereof will be omitted herein.

Referring to FIG. 1, the second image generating unit 170 generates the second image by using the charge quantities (Q_{0°}−Q_{180°} and Q_{90°}−Q_{270°}) received from the sensing unit 130. In detail, the second image generating unit 170 may generate the second image by using Equation 2 below.

$$Depth = {tan}^{- 1} ( \frac{{Q}_{90} - {Q}_{270}}{{Q}_{0} - {Q}_{180}} ) \times {R}_{max} \qquad [ Equation 2 ]$$

In Equation 2, Q_{0°}−Q_{180°} and Q_{90°}−Q_{270°} denotes the charge quantities received from the sensing unit 130. Also, Rₘₐₓ is a value based on the velocity of light and a modulation frequency of the third light (“irradiated light” in FIG. 5), and denotes a theoretical distance that may be acquired by the sensor included in the sensing unit 130. For example, when the modulation frequency of the third light is about 30 MHz, Rₘₐₓ may be about 5 m, and when the modulation frequency of the third light is about 20 MHz, Rₘₐₓ may be about 7.5 m. That is, Rₘₐₓ is calculated by the second image generating unit 170 based on the modulation frequency of the third light that is determined by the control unit 140.

Based on the result (Depth) of Equation 2, the second image generating unit 170 determines a brightness value of each of the pixels constituting the image. For example, based on a lookup table, the second image generating unit 170 determines the brightness value of each of the pixels such that the brightness value of the pixel is “b” when the calculated depth is “a”. Thereafter, the second image generating unit 170 generates the second image based on the determined brightness value of the pixel.

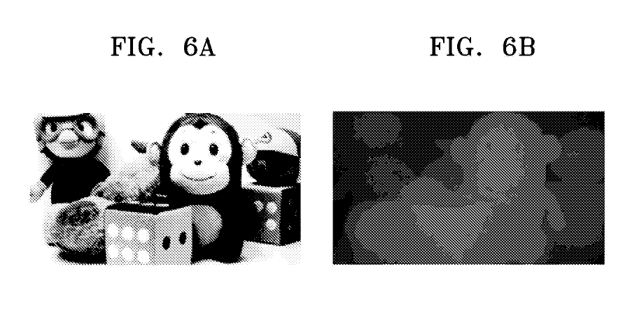

FIGS. 6A-6B are examples illustrating an operation of the second image generating unit 170 (see FIG. 1).

FIG. 6A illustrates an image of the actual position of objects 190 (see FIG. 1), and FIG. 6B illustrates the second image (i.e., the depth image) generated by the second image generating unit 170 (see FIG. 1).

Referring to FIG. 6B, it may be seen that the brightness values of the objects 190 (see FIG. 1) in the second image are different from each other according to the distances of the object 190 (see FIG. 1). In detail, the object 190 (see FIG. 1) close to the image generating apparatus 100 (see FIG. 1) appears relatively bright in the second image, and the object 190 (see FIG. 1) remote from the image generating apparatus 100 (see FIG. 1) appears relatively dark in the second image.

Therefore, the image generating apparatus 100 (see FIG. 1) may generate the depth image corresponding to the actual position of the object 190 (see FIG. 1) by removing visible light by using the sensor included in the sensing unit 130 (see FIG. 130).

Referring to FIG. 1, the control unit 140 generates control signals for controlling respective elements of the image generating apparatus 100 and transmits the control signals to the respective elements. In detail, the control unit 140 generates control signals for controlling the operations of the filtering unit 120, the sensing unit 130, the light irradiation unit 150, the first image generating unit 160, and the second image generating unit 170 that are included in the image generating apparatus 100.

Although not shown in FIG. 8, a display unit, which is comprised the image generating apparatus 100, displays the first image or the second image. For example, the display unit displays the first image and the second image respectively. And, the display unit displays a combined image which includes the first image and the second image. For example, the display unit includes any of output units provided in the image generating apparatus 100 such as a display panel, a liquid crystal display (LCD) screen, or a monitor.

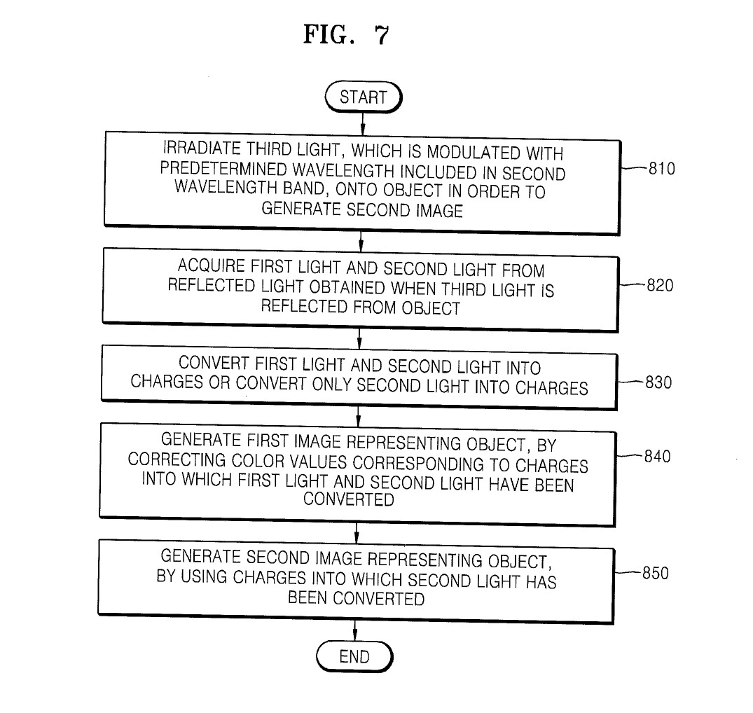

FIG. 7 is a flow diagram illustrating an example of an image generating method.

Referring to FIG. 7, the image generating method includes sequential operations performed in the image generating apparatus 100 (see FIG. 1). Therefore, even when there are contents omitted in the following description, the contents described above in relation to the image generating apparatus 100 (see FIG. 1) may also be applied to the image generating method of FIG. 7.

In operation 810, when the image generating apparatus 100 (see FIG. 1) generates the second image, the light irradiating unit 150 (see FIG. 1) irradiates the third light 180 (see FIG. 1), which is modulated with a predetermined frequency included in the second wavelength band, onto the object 190 (see FIG. 1).

In operation 820, the filtering unit 120 (see FIG. 1) acquires the first light 210 (see FIG. 2) and the second light 220 (see FIG. 2) from the reflected light 185 (see FIG. 1) obtained when the third light 180 (see FIG. 1) is reflected from the object 190 (see FIG. 1).

In operation 830, the sensing unit 130 (see FIG. 1) converts both the first light 210 (see FIG. 2) and the second light 220 (see FIG. 2) into charges or converts only the second light 220 (see FIG. 2) into charges. That is, the sensing unit 130 (see FIG. 1) converts the first light 210 (see FIG. 2) and the second light 220 (see FIG. 2), which are received from the filtering unit 120 (see FIG. 1), into charges, or removes the first light 210 (see FIG. 2) and converts only the second light 220 (see FIG. 2) into charges.

In operation 840, the first image generating unit 160 (see FIG. 1) generates the first image representing the object 190 (see FIG. 1) by correcting the color values corresponding to the charges into which the first light 210 (see FIG. 2) and the second light 220 (see FIG. 2) have been converted.

In operation 850, the second image generating unit 170 (see FIG. 1) generates the second image representing the object 190 (see FIG. 1) by using the charges into which the second light 220 (see FIG. 2) has been converted.

As described above, according to the one or more of the above embodiments, the image generating apparatus 100 (see FIG. 1) may transmit visible light and infrared light without mechanical or electrical control of the filter by using the single filter, thus making it possible to reduce the size of an image generating apparatus. Also, since an additional time for filter driving is not necessary, the image generating apparatus 100 (see FIG. 1) may rapidly generate a color image and a depth image.

Also, the image generating apparatus 100 (see FIG. 1) may generate a more clear and realistic color image of the object 190 (see FIG. 1) by correcting a color distorted by infrared light. Also, the image generating apparatus 100 (see FIG. 1) may generate a depth image corresponding to the actual position of the object 190 (see FIG. 1) by removing information about visible light by using the sensor when generating a depth image of the object 190 (see FIG. 1).

In addition, embodiments may also be implemented through non-transitory computer readable code/instructions in/on a medium, e.g., a computer readable medium, to control at least one processing element to implement any above described embodiment. The medium may correspond to any medium/media permitting the storage and/or transmission of the computer readable code.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

It should be understood that exemplary embodiments described therein should be considered in a descriptive sense only and not for purposes of limitation. Descriptions of features or aspects within each embodiment should typically be considered as available for other similar features or aspects in other embodiments.

While exemplary embodiments have been described above, it will be understood by those or ordinary skill in the art that various changes in form and details may be made therein without departing from the spirit and scope of the present disclosure as defined by the appended claims and their equivalents. Exemplary embodiments should be considered in descriptive sense only and not for purposes of limitation. Therefore, the scope of the present disclosure is defined not by the above description but by the appended claims and their equivalents, and all differences within the scope will be construed as being included in the scope of the present disclosure.

What is claimed is:

1. An apparatus for generating an image representing an object, comprising:
a filter to acquire first light of a first wavelength band and second light of a second wavelength band, which are included in light reflected from the object, by using a single filter;
a sensor to convert both the first light and the second light into charges or convert only the second light into charges;
a first image generator to generate a first image representing the object by correcting color values corresponding to the charges into which the first light and the second light have been converted; and
a second image generator to generate a second image representing the object by using the charges into which the second light has been converted.

2. The apparatus of claim 1, further comprising a light irradiator to irradiate third light, which is modulated with a predetermined frequency included in the second wavelength band, onto the object in order to generate the second image,
wherein the filter acquires the first light and the second light from reflected light obtained when the third light is reflected from the object.

3. The apparatus of claim 2, wherein the second image generator is configured to generate the second image by combining charges detected when photodiode circuits included in the sensor operate with a predetermined phase difference therebetween, among the charges into which the second light has been converted.

4. The apparatus of claim 3, wherein the photodiode circuits included in the sensor operate with a phase difference of about 180° therebetween.

5. The apparatus of claim 3, wherein the photodiode comprises one of a pint photodiode and a photogate.

6. The apparatus of claim 1, wherein the first image generator is configured to generate the first image by correcting the color values corresponding to the charges based on maximum color values of the sensor.

7. The apparatus of claim 1, wherein the first image includes a color image representing the object, and the second image includes a depth image representing the object.

8. A method for generating an image representing an object, comprising:
acquiring first light of a first wavelength band and second light of a second wavelength band, which are included in light reflected from the object;
converting both the first light and the second light into charges or converting only the second light into charges;
generating a first image representing the object by correcting color values corresponding to the charges into which the first light and the second light have been converted; and
generating a second image representing the object by using the charges into which the second light has been converted.

9. The method of claim 8, further irradiating third light, which is modulated with a predetermined frequency included in the second wavelength band, onto the object in order to generate the second image,
wherein the first light and the second light are acquired from reflected light obtained when the third light is reflected from the object.

10. The method of claim 8, wherein the second image is generated by combining charges detected with a predetermined phase difference, among the charges into which the second light has been converted.

11. The method of claim 10, wherein the charges are detected with a phase difference of about 180° therebetween.

12. The method of claim 11, wherein the charges are detected by using a photodiode including one of a pint photodiode and a photogate.

13. The method of claim 8, wherein the first image is generated by correcting the color values corresponding to the charges based on maximum color values of a sensor.

14. The method of claim 8, wherein the first image includes a color image representing the object, and the second image includes a depth image representing the object.

15. At least one non-transitory computer-readable medium storing computer-readable instructions that when executed implement the method of claim 8.
